(19) United States
(12) Patent Application Publication
(10) Pub. No.: US 2005/0034152 A1
(43) Pub. Date: Feb. 10, 2005

(54) Receiving apparatus and receiving method

(75) Inventors: Yuichi Matsumoto, Kanagawa (JP); Yoshikazu Shibamiya, Kanagawa (JP); Tomoyuki Ohno, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/651,957

(22) Filed: Sep. 2, 2003

(30) Foreign Application Priority Data
Sep. 9, 2002 (JP) 2002-262848

(51) Int. Cl. H04N 7/025; H04N 7/16; H04N 7/10

(52) U.S. Cl. 725/32; 725/135; 725/136

(57) ABSTRACT

To promptly receive stream data of high definition and a high frame rate, a receiving apparatus receives via a network a digest stream including digest data showing digests of a plurality of main video images and position information showing a position on the network of connection information for receiving the plurality of main video images, receives the connection information via the network on the basis of the position information in the received digest stream, and receives main video data in accordance with the connection information.

### BACKGROUND OF THE INVENTION

1. Field of the Invention

The invention relates to a receiving apparatus and a receiving method and, more particularly, to a technique for receiving stream data via a network.

2. Related Background Art

In recent years, Internet broadcast and reproduction have been widespread in association with the improvement of a compressing technique of video/audio data and the spread of a communication environment and an Internet environment which enable high-speed data transfer to be realized. In the Internet broadcast, mainly a downloading type broadcast and a streaming broadcast exist.

In the downloading type broadcast, it is necessary to download all contents onto a receiver side and, thereafter, reproduce them. If the contents is the contents of a long time, a file size becomes extremely large and a time that is required for downloading increases, so that storing means of a large capacity for storing the contents data to be downloaded is necessary.

In the streaming broadcast, data can be reproduced while it is received. Since reproduction becomes possible first by buffering the contents as much a few seconds as measured by time, the data can be reproduced in a time shorter than the downloading time of the contents in the downloading type broadcast. Since the data can be abandoned when its reproduction has been finished, it is sufficient that the capacity of the storing means which should be prepared on the receiver side and is used for storing the contents data can be small.

However, even in the Internet broadcast, there is a tendency such that resolution of the contents, a frame frequency, and the like rise in order to realize a good video image of a large display screen and high definition.

Also in the streaming broadcast, there is a problem such that it is necessary to buffer the contents of a few seconds at the beginning of monitoring and it takes a long time until the reproduction in association with the increase in resolution of the contents and frame frequency.

According to JP-A-2001-54090, a technique for easily searching contents, a technique for reproducing the contents by the simple operation, and a technique for enabling the contents to be monitored in a short time have been proposed with respect to the streaming broadcast.

However, only low-bit rate contents can be monitored in a short time and there is no effect on the streaming contents of high resolution and a high frame frequency.

### SUMMARY OF THE INVENTION

It is an object of the invention to provide a receiving apparatus and a receiving method in which the operation for monitoring streaming contents of high quality can be easily and conveniently executed.

Another object of the invention is to provide a receiving apparatus and a receiving method in which stream data of high definition and a high frame rate can be rapidly received.

According to one aspect of the invention, there is provided a receiving method of receiving stream data including main video data via a network, comprising the steps of:

receiving via the network a digest stream including digest data showing a digest of each of the plurality of main video data and position information showing a position on the network where connection information for connecting to at least one of the plurality of main video data exists;

outputting a video signal regarding the received digest data in order to display it; and

controlling communicating means so as to receive the connection information via the network on the basis of the received connection information and receive the main video data in accordance with the connection information.

According to another aspect of the invention, there is provided a receiving apparatus for receiving stream data including main video data via a network, comprising:

communicating means for receiving via the network a digest stream including digest data showing a digest of each of the plurality of main video data and position information showing a position on the network where connection information for connecting to the plurality of main video data;

outputting means for outputting a video signal regarding the digest data in the digest stream received by the communicating means to a display apparatus;

system control means for controlling the communicating means so as to receive the connection information via the network on the basis of the position information in the digest stream received by the communicating means and receive the main video data in accordance with the connection information; and

storing means for storing the received main video data by a predetermined amount.

The system control means can further control display control means so that the main video data stored in the storing means is outputted to the display apparatus in response to a display instruction of a main video image by instructing means in place of the video signal regarding the digest stream.

The system control means can control the communicating means and the storing means so that only the main video data corresponding to the digest data regarding a video image which is being displayed by the display apparatus is received and stored into the storing means.

Further, the system control means can control the communicating means and the storing means so that the main video data which is received by the communicating means is changed in accordance with a change in position information in the digest stream and the main video data which is newly received after the change is stored into the storing means.

Or, the system control means can control the communicating means and the storing means so that a plurality of main video data corresponding to the digest data regarding a video image which is being displayed by the display apparatus and a plurality of digest data subsequent to the digest data is received and stored into the storing means.

The system control means can further control the display control means so that the main video data corresponding to the video signal outputted to the display apparatus among the plurality of main video data stored in the storing means is outputted to the display apparatus in place of the video signal regarding the digest stream in response to a reproducing instruction of the main video image by reproduction instructing means.

The system control means can control the display control means so that if the instruction is made by the reproduction instructing means while the main video data is outputted to the display apparatus, a predetermined one of the plurality of main video data stored in the storing means is read out and outputted in place of the video data which is being displayed.

The system control means can control the communicating means and the storing means so that the main video data which is received by the communicating means is changed in accordance with the instruction made by the reproduction instructing means and the newly received main video data is stored in place of the main video data of one of the video data other than the predetermined main video data among the plurality of main video data stored in the storing means.

The system control means can control the storing means so that when an instruction is made by reservation instructing means, the newly received main video data is stored in place of the video data other than the video data instructed by the reservation instructing means among the plurality of main video data stored in the storing means.

The system control means can control the communicating means and the storing means so that the plurality of main video data is received and stored in order according to priorities of the plurality of main video data.

The priorities can correspond to reproducing order in the digest stream.

The system control means can the control display control means so that predetermined information is displayed by the display apparatus in accordance with an amount of main video data stored in the storing means.

The position information includes a URL of the connection information. The connection information can be described in a markup language such as HTML or XML.

The invention includes a program distribution server and a program distributing method for transmitting the digest stream to the foregoing receiving apparatus via the network.

Or, the invention includes a program distribution server and a program distributing method for distributing the connection information and the main video data to the foregoing receiving apparatus via the network.

The invention includes a distribution system comprising the receiving apparatus and the program distribution server.

### BRIEF DESCRIPTION OF THE DRAWINGS

FIG. 1 is a constructional diagram of a streaming program distribution system to which the invention is applied;

FIG. 2 is a schematic diagram of a URL table;

FIGS. 3A and 3B are diagrams showing an example of contents of the URL table;

FIG. 4 is a diagram showing a state upon monitoring of a digest program;

FIG. 5 is a diagram showing a format of a UDP packet;

FIG. 6 is a diagram showing an example of contents of the UDP packet;

FIG. 7 is a diagram showing an example of contents of the UDP packet;

FIG. 8 is a diagram showing an example of contents of the UDP packet;

FIG. 9 is a diagram showing a state upon monitoring of a current program;

FIG. 10 is a time-dependent transition diagram of display contents of a display unit 3100 and contents of data which is transferred from an FIFO 3050 to an FIFO 3051;

FIG. 11 is a time-dependent transition diagram of display contents of the display unit 3100 and contents of data which is transferred from the FIFO 3050 to the FIFO 3051;

FIG. 12 is a time-dependent transition diagram of display contents of the display unit 3100 and contents of data which is transferred from the FIFO 3050 to the FIFO 3051;

FIG. 13 is a diagram showing a state upon monitoring of the current program;

FIG. 14 is a constructional diagram of a streaming program distribution system in the second embodiment;

FIG. 15 is a diagram showing a format of a UDP packet in the second embodiment;

FIG. 16 is a diagram showing an example of contents of the UDP packet;

FIG. 17 is a diagram showing an example of contents of the UDP packet;

FIG. 18 is a diagram showing an example of contents of the UDP packet;

FIG. 19 is a time-dependent transition diagram of display contents of the display unit 3100 and contents of data which is transferred from the FIFO 3050 to an FIFO 3053;

FIG. 20 is a time-dependent transition diagram of display contents of the display unit 3100 and contents of data which is transferred from the FIFO 3050 to the FIFO 3053;

FIG. 21 is a time-dependent transition diagram of display contents of the display unit 3100 and contents of data which is transferred from the FIFO 3050 to the FIFO 3053;

FIG. 22 is a diagram showing a state after the operation of a reservation button;

FIG. 23 is a time-dependent transition diagram of display contents of the display unit 3100 and contents of data which is transferred from the FIFO 3050 to the FIFO 3053;

FIG. 24 is a diagram showing a state after the operation of the reservation button;

FIG. 25 is a time-dependent transition diagram of display contents of the display unit 3100 and contents of data which is transferred from the FIFO 3050 to the FIFO 3053;

FIG. 26 is a constructional diagram of the streaming program distribution system to which the invention is applied;

FIG. 27 is a schematic diagram of a URL table;

FIG. 28 is a diagram showing an example of contents of the UDP table;

FIG. 29 is a processing flow for a buffering processing; and

FIG. 30 is a time-dependent transition diagram of display contents of the display unit 3100 and contents of data which is transferred from the FIFO 3050 to the FIFO 3053.

### DETAILED DESCRIPTION OF THE PREFERRED EMBODIMENTS

(First Embodiment)

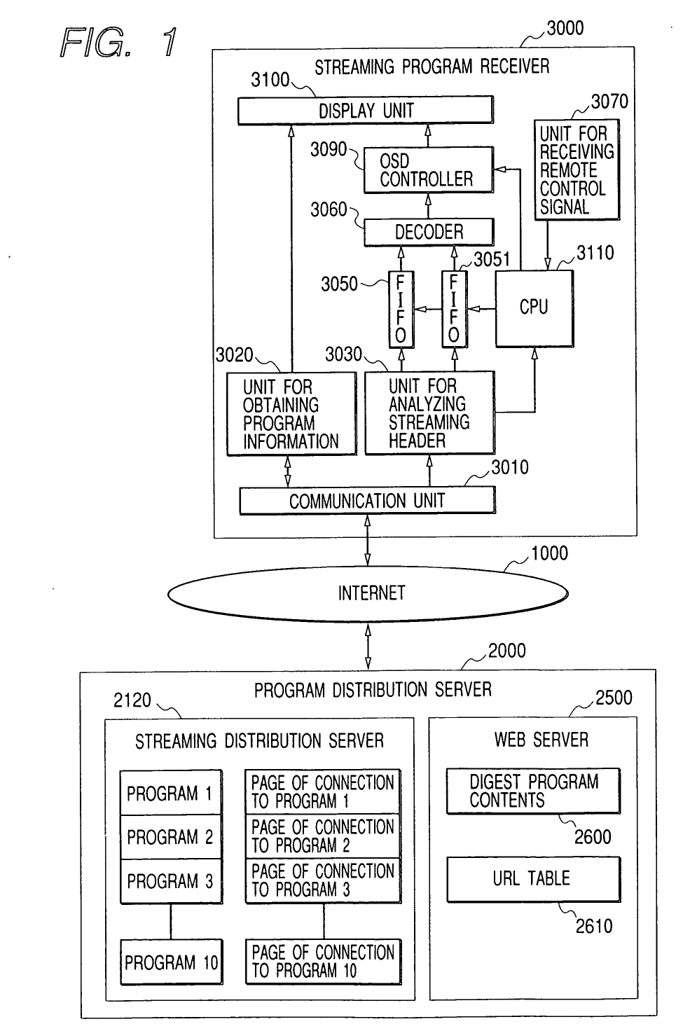

A streaming program distribution system according to the first embodiment to which the invention is applied will be described hereinbelow with reference to the drawings. FIG. 1 is a diagram showing a construction of a main section of the streaming program distribution system in the first embodiment.

In FIG. 1, reference numeral 1000 denotes an Internet for transmitting streaming program data, program information, and the like. Reference numeral 2000 denotes a program distribution server for executing accumulation, storage, transmission, and the like of streaming program contents, program information, and the like. The program distribution server 2000 comprises: a streaming distribution server 2100 for distributing a streaming program to a streaming program receiver; and a WEB server 2500 for distributing the program information to the streaming program receiver.

The streaming program data constructed by a video image and an audio sound has been stored in the streaming distribution server 2100. Ten streaming program data of programs 1 to 10 has been stored here At the same time, a document (HTML document, here) described in ten markup languages which correspond to the programs 1 to 10 and include connection information to each program has been stored. Peculiar URLs have been allocated to each streaming program data and HTML document. The streaming distribution server 2100 can be accessed from the WEB server 2500 or the outside via the Internet 1000.

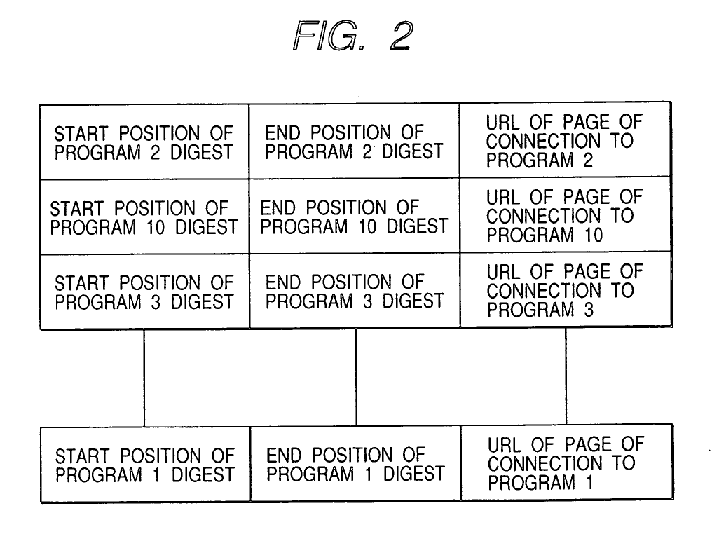

Digest program contents 2600 comprising digest scenes of the programs stored in the streaming distribution server 2100 has been stored in the WEB server 2500. The WEB server 2500 also has a URL table 2610 in which a start position and an end position of each program digest in the digest program contents 2600 and the URL of HTML document data including connection information indicative of the connection to each streaming program are made to correspond to each other. Each HTML document is described so as to receive and display each of the corresponding streaming programs as streaming data. A schematic diagram of the URL table is shown in FIG. 2.

For example, the URLs of the HTML document including the connection information to each program are as follows.

```
//host/prog1.htm
//host/prog2.htm
//host/prog3.htm
    .
    .
//host/prog10.htm
```

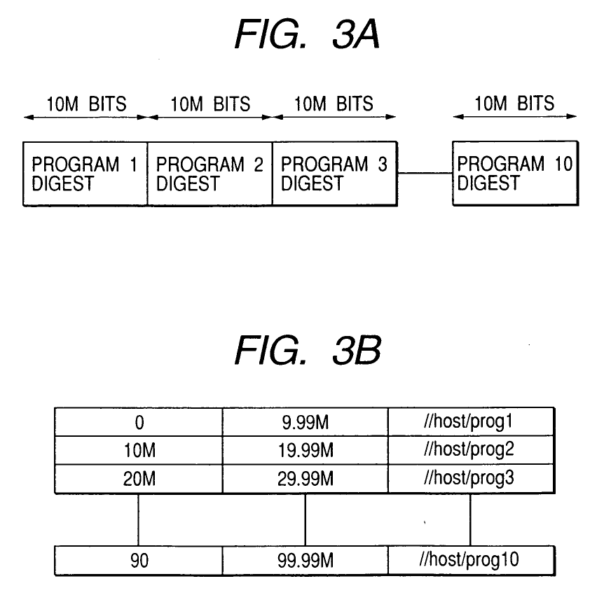

If the program digest scene of each of the programs 1 to 10 in the digest program contents 2600 has a data capacity of 10 Mbits (FIG. 3A), the URL table 2610 is as shown in FIG. 3B.

A portal display screen of the WEB server 2500 itself is held in the HTML document. The HTML document is described so that the digest program contents 2600 is received and displayed as streaming data. A transferring protocol in this instance is described as a UDP (User Datagram Protocol) and the number of a port which is used is described as 200.

Reference numeral 3000 denotes a streaming program receiver for requesting streaming program data, program information, etc. of the program distribution server 2000, receiving them from the program distribution server 2000, and displaying them onto the display unit 3100. Reference numeral 3010 denotes a communication unit for transmitting and receiving data to/from the Internet 1000. When the communication unit 3010 receives the program information data from the Internet 1000, it transfers the program information data to a unit 3020 for obtaining the program information. When the communication unit 3010 receives the streaming data, it transfers the streaming data to a unit 3030 for analyzing a streaming header. Reference numeral 3020 denotes the program information obtaining unit which is constructed in a manner similar to an Internet browser in a personal computer. The program information obtaining unit 3020 requests the HTML document having the program information from the program distribution server 2000, receives the HTML document from the program distribution server 2000, analyzes it, and displays it onto the display unit 3100. The streaming header analyzing unit 3030 analyzes the header in the streaming data and notifies a CPU 3110 of a result of the analysis.

Reference numerals 3050 and 3051 denote FIFOs serving as buffers for buffering the streaming program data necessary for reproduction of the streaming program. Reference numeral 3060 denotes a decoder for reading out the streaming program data from the FIFOs, decoding the video image and audio sound, outputting the decoded video image, and outputting the decoded audio sound from an audio output unit (not shown). Reference numeral 3090 denotes an OSD controller for superimposing characters, a figure, or the like instructed by the CPU 3110 onto the output video image from the decoder 3060 and displaying a resultant video image onto the display unit 3100.

Reference numeral 3070 denotes a unit for receiving a remote control signal. The remote control signal receiving unit 3070 receives and decodes infrared rays transmitted from a remote controller (not shown) and outputs a code of a button of the remote controller operated by the user. Reference numeral 3110 denotes the CPU serving as a controller. The CPU 3110 is constructed so that the button of the remote controller operated by the user can be discriminated via the remote control signal receiving unit 3070 and further integratedly controls each component element. The CPU 3110 has a memory. The CPU 3110 operates in accordance with a program stored in the memory and controls each of the component elements.

In the above construction, the operation of the streaming program distribution system in the embodiment will be described hereinbelow.

First, the streaming program receiver 3000 requests the HTML document on the portal display screen from the program distribution server 2000 via the Internet 1000. The program distribution server 2000 which received the request transmits the relevant HTML document to the streaming program receiver 3000. The program information obtaining unit 3020 which received the HTML document analyzes the HTML document and displays its contents onto the display unit 3100.

Since the HTML document has the description showing that the digest program contents 2600 is received and displayed as streaming data as mentioned above, the digest program contents 2600 is received and displayed onto the display unit 3100.

The operation which is executed until the display of the digest program contents 2600 will be described hereinbelow.

First, the streaming program receiver 3000 obtains the URL, protocol (UDP here as mentioned above), port number (200 here as mentioned above), and the like of the digest program contents 2600 from the HTML document, requests the WEB server 2500 to establish a connection on the basis of those information, and establishes a connection for the digest program contents 2600 between the streaming program receiver 3000 and the WEB server 2500. The streaming program receiver 3000 requests the WEB server 2500 to transmit the digest program contents 2600, so that the digest program contents 2600 is transmitted from the WEB server 2500 to the streaming program receiver 3000.

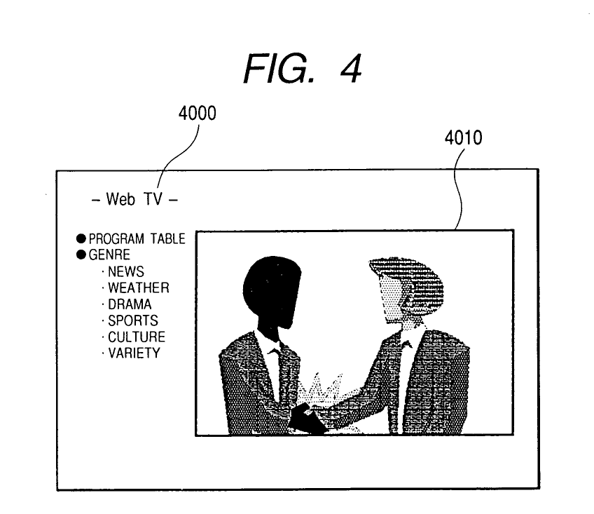

In the streaming program receiver 3000, the received digest program contents 2600 is buffered into the FIFO 3050 via the streaming header analyzing unit 3030 and, thereafter, it is decoded by the decoder 3060 and displayed onto the display unit 3100. Display contents on the display unit 3100 at this time are shown in FIG. 4. In the diagram, reference numeral 4000 denotes a background instructed by the HTML document of the portal display screen. Reference numeral 4010 denotes a reproduction display screen of the digest program contents 2600. While the digest program contents 2600 is reproduced, the streaming program receiver 3000 requests the WEB server 2500 to execute continuation of the transmission, interruption, or the like of the digest program contents 2600 in accordance with an amount of data in the FIFO 3050.

Subsequently, the characteristic operation in the embodiment will be described hereinbelow.

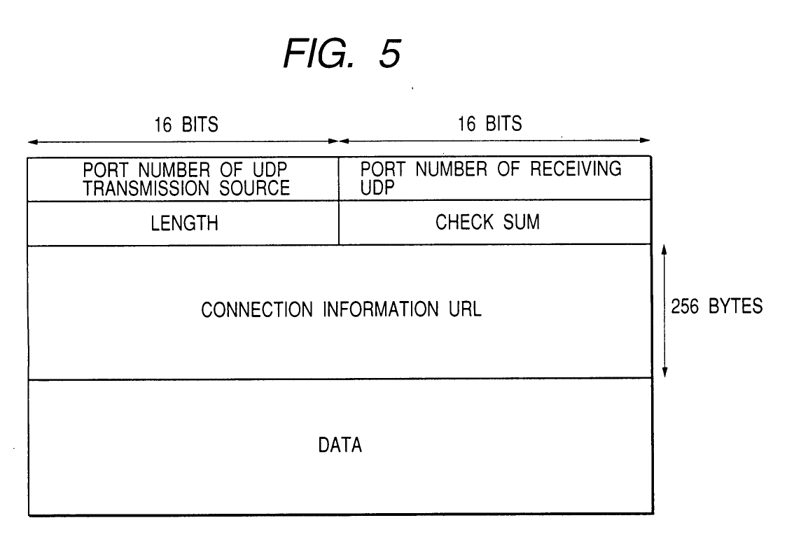

First, in the WEB server 2500, when the digest program contents 2600 is transmitted to the streaming program receiver 3000, the URL of the HTML document data including the connection information corresponding to the position of the transmission data is transmitted together with the transmission data. In this instance, the URL is transmitted just after the UDP header and, subsequently, the data of the digest program contents 2600 is transmitted. A data format in this instance is shown in FIG. 5. In FIG. 5, it is assumed that an area of the connection information URL is fixed to 256 bytes.

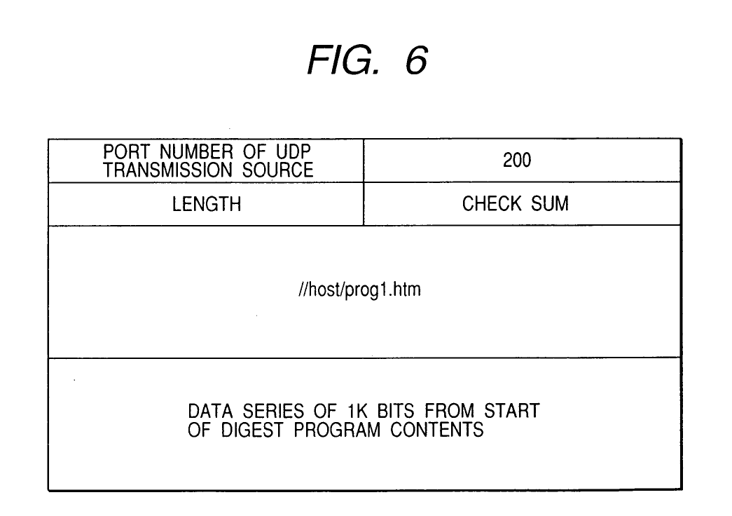

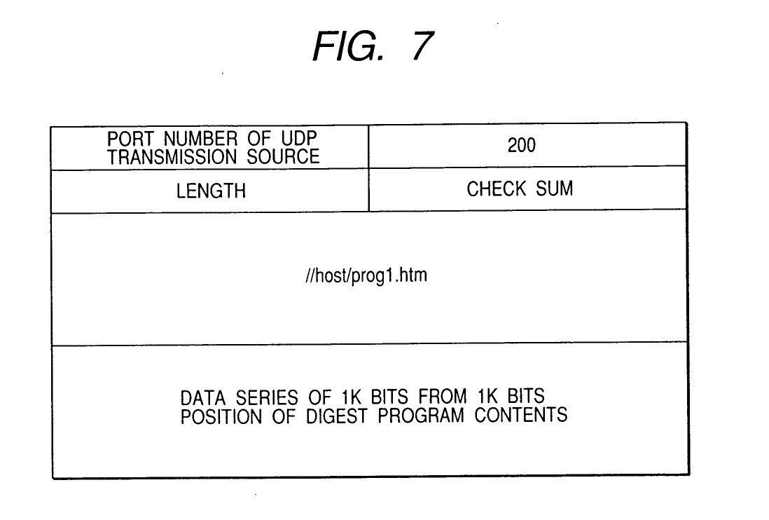

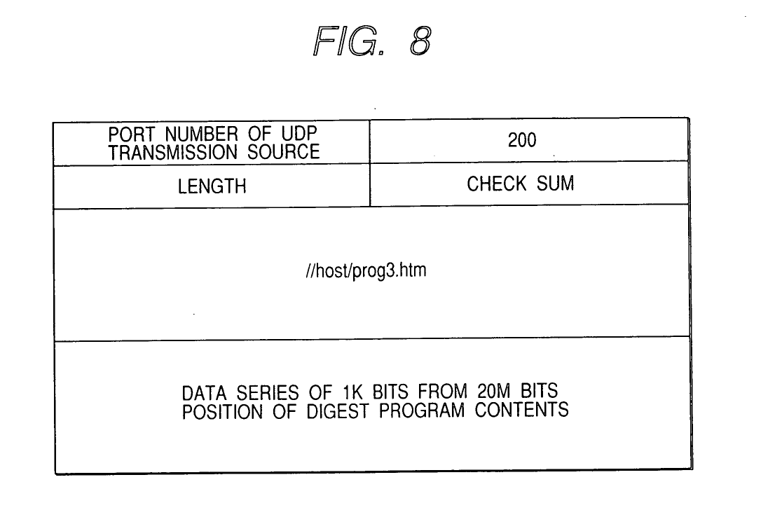

For example, in the case of transmitting the data of 1 kbits from the start of the digest program contents 2600, the URL of the HTML document data corresponding to the transmission data position is identified as “//host/prog1.htm” from the URL table 2610 and data shown in FIG. 6 is transmitted. In the case of transmitting the subsequent data, that is, the data of 1 kbits from the 1-kbits position of the digest program contents 2600, the URL of the HTML document data corresponding to the transmission data position is identified as “//host/prog1.htm” from the URL table 2610 in a manner similar to that mentioned above and data shown in FIG. 7 is transmitted. In the case of transmitting the data of 1 kbits from the 20-Mbits position of the digest program contents 2600, the URL of the HTML document data corresponding to the transmission data position is identified as “//host/prog3.htm” from the URL table 2610 and data shown in FIG. 8 is transmitted.

In the streaming program receiver 3000, first, the connection information URL in the received digest program contents 2600 is analyzed in the streaming header analyzing unit 3030. For example, in the case of receiving the data of 1 kbits from the start of the digest program contents 2600, the data shown in FIG. 6 is received and the connection information URL is identified as “//host/prog1.htm”.

Since the connection information URL has changed (from a state where the connection information URL is not received to a state where it is received), the streaming program receiver 3000 requests the HTML document of “//host/prog1.htm” on the basis of the URL. This request is made by the URL to the streaming distribution server 2100. The streaming distribution server 2100 transmits the HTML document of “//host/prog1.htm” to the streaming program receiver 3000 on the basis of the request. Since the HTML document has the description showing that the program 1 is received and displayed as streaming data as mentioned above, the program information obtaining unit 3020 which received the HTML document starts to receive the program 1.

Although the receiving operation here is similar to the operation upon reception of the digest program contents 2600 mentioned above, the data is not reproduced and displayed. The data of the program 1 which is received is buffered into the FIFO 3051. Since the reproduction and display are not executed, the streaming program receiver 3000 requests the program distribution server 2000 to execute the interruption or the like of the data in accordance with the amount of data in the FIFO 3051, thereby performing the operation to prevent a loss of data.

The streaming program receiver 3000 is constructed in a manner such that the header of the streaming data which is the UDP and is connected to the port 200 is analyzed by the streaming header analyzing unit 3030. Therefore, the header of the streaming data of the program 1 is not analyzed.

Subsequently, when the streaming program receiver 3000 receives the subsequent data, that is, the data (the data shown in FIG. 7) of 1 kbits from the 1-kbits position of the digest program contents 2600, the connection information URL is again identified as “//host/prog1.htm” in the streaming header analyzing unit 3030. In this case, the streaming program receiver 3000 does not execute the special operation such as connection establishment or the like as mentioned above.

After that, when the data of 1 kbits from the 10-Mbits position of the digest program contents 2600 is received, the connection information URL is identified as “//host/prog2.htm” in the streaming header analyzing unit 3030. In this case, since the connection information URL has changed, the streaming program receiver 3000 stops the data reception of the program 1, disconnects the connection, and requests the HTML document of “//host/prog2.htm” on the basis of the URL. After that, the streaming program receiver 3000 operates in a manner similar to the foregoing processing and starts to receive the program 2. At this time, the data of the program 1 buffered in the FIFO 3051 is abandoned and the data of the program 2 which is newly received is buffered in the FIFO 3051.

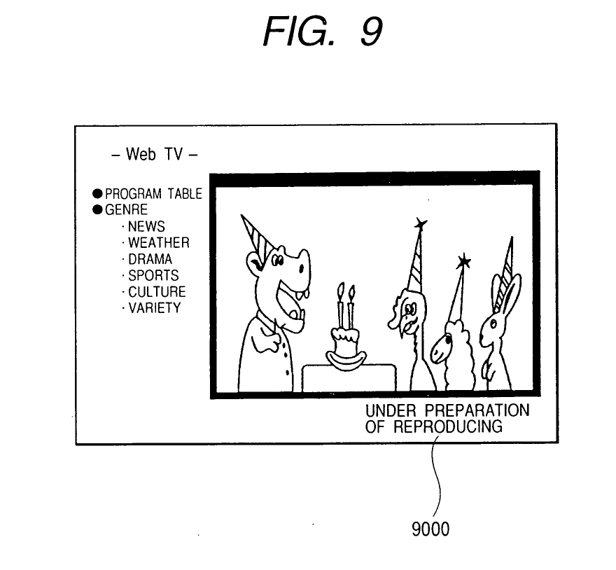

While the data of the program 1 buffered during the above operation is abandoned and an amount of data of the program 2 which is newly received in the FIFO 3051 reaches a capacity of the data which can be reproduced, a message showing such a fact is displayed via the OSD controller 3090. Contents displayed on the display unit 3160 at this time are shown at 9000 in FIG. 9.

Similarly, when the data (shown in FIG. 8) of 1 kbits from the 20-Mbits position of the digest program contents 2600 is received, the connection information URL is identified as “//host/prog3.htm” in the streaming header analyzing unit 3030 and the data of the program 2 is buffered into the FIFO 3051.

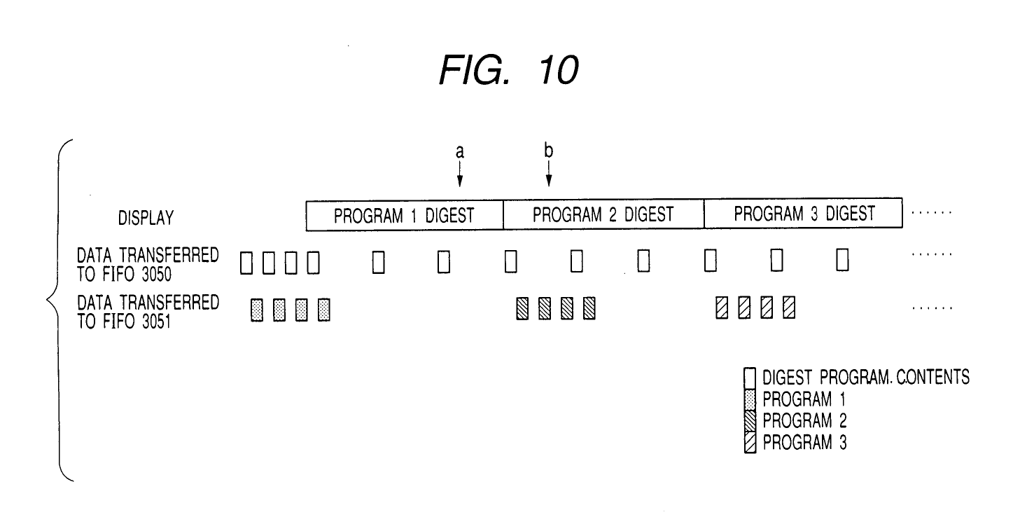

A time-dependent transition diagram of the display contents on the display unit 3100 and the contents of data which is transferred to the FIFOs 3050 and 3051 in the above operation is shown in FIG. 10.

In FIG. 10, the operation which is executed when the user operates a monitoring button on the remote controller at a point of time “a” will be described hereinbelow. It corresponds to the case where while the user monitors the digest scene of the program 1 of the digest program contents 2600 on the portal display screen, he likes the monitoring program, that is, the program 1 and shifts the monitoring target to the current program.

The CPU 3110 which detected the operation of the monitoring button controls the decoder 3060 so as to read out the streaming data from the FIFO 3051 because the data in the FIFO 3051 is in a reproducible state, and switches the display contents on the display unit 3100 to the reproduction display screen of the program 1. At the same time, the reception of the digest program contents 2600 is stopped and the connection is disconnected.

After that, since the reception of the digest program contents 2600 is stopped, the change in connection information URL is not detected in the streaming header analyzing unit 3030 but the reception of the data of the program 1 is continued and the reproduction display screen of the program 1 is continuously displayed on the display unit 3100.

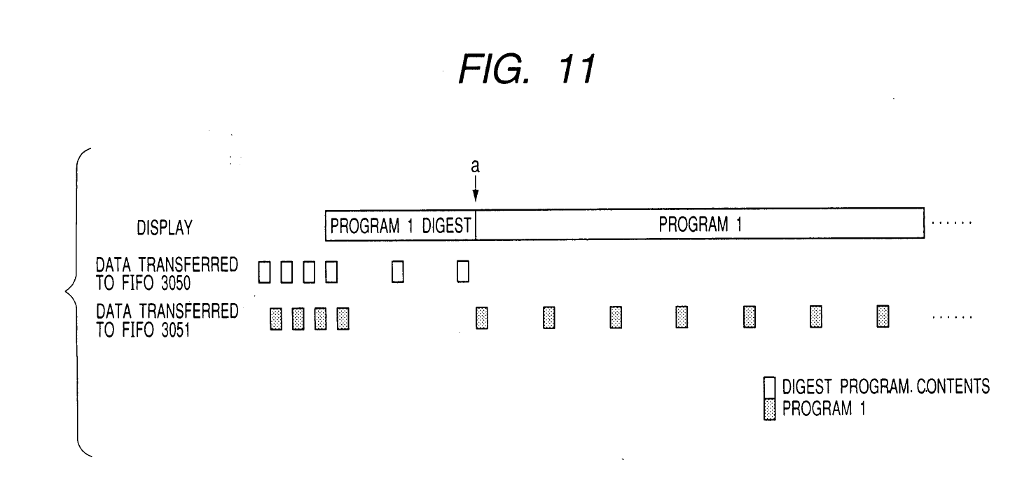

A time-dependent transition diagram of the display contents on the display unit 3100 and the contents of data which is transferred to the FIFOs 3050 and 3051 in this case is shown in FIG. 11.

As mentioned above, while the digest program is monitored, the user can soon start to monitor the current program without a waiting time for buffering or the like by the simple operation such as only the operation of the monitoring button.

Returning to FIG. 10, the operation which is executed when the user operates the monitoring button on the remote controller at a point of time “b” will be described hereinbelow. It corresponds to the case where while the user monitors the digest scene of the program 2 of the digest program contents 2600 on the portal display screen, he likes the monitoring program, that is, the program 2 and shifts the monitoring target to the current program.

The CPU 3110 which detected the operation of the monitoring button waits until the apparatus enters the reproducible state because the data in the FIFO 3051 is in an unreproducible state. When the data in the FIFO 3051 enters the reproducible state, the CPU 3110 switches the decoder 3060 so as to read out the streaming data from the FIFO 3051 and switches the display contents on the display unit 3100 to the reproduction display screen of the program 2. At the same time, the reception of the digest program contents 2600 is stopped and the connection is disconnected.

After that, the reproduction display screen of the program 2 is continuously displayed on the display unit 3100 in a manner similar to that mentioned above.

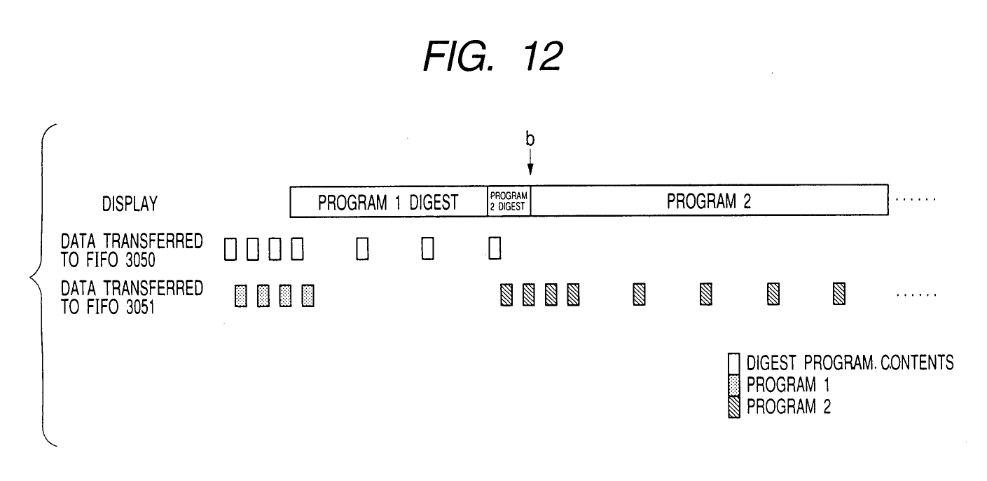

A time-dependent transition diagram of the display contents on the display unit 3100 and the contents of data which is transferred to the FIFOs 3050 and 3051 in the above case is shown in FIG. 12.

As mentioned above, the user can monitor the current program by the simple operation such as only the operation of the monitoring button. Since the buffering of the current program is started together with the switching of the contents of the digest program contents 2600, the waiting time until the start of monitoring is shorter than that in the conventional technique.

Since the digest program can be monitored for the waiting time until the monitoring of the current program, the user does not feel mental annoyance. Until the data amount reaches the capacity of the data which can be reproduced, a message indicative of such contents is displayed as shown in FIG. 9. Therefore, the user can easily distinguish the digest program contents. 2600 from the current program.

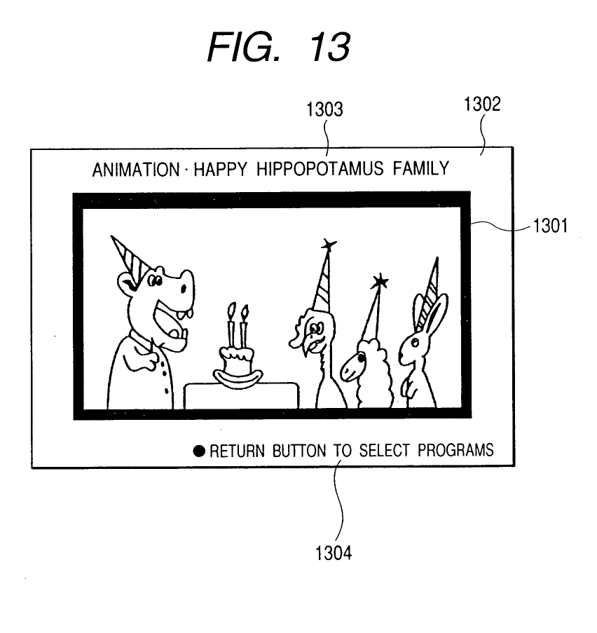

FIG. 13 shows display contents on the display unit 3100 upon monitoring of the current program. In FIG. 13, reference numeral 1301 denotes a reproduction display screen of the current program and 1302 indicates a background on which a program title 1303 and an operation description 1304 are displayed. Those backgrounds have been described in the HTML document including the connection information.

As shown in the operation description 1304, when the user operates a return button on the remote controller, the streaming program receiver 3000 requests the HTML document on the portal display screen from the program distribution server 2000 via the Internet 1000 and repeats the above operations.

(Second embodiment)

A streaming program distribution system according to the second embodiment to which the invention is applied will be described hereinbelow. A construction of a main section of the streaming program distribution system in the second embodiment is similar to that of FIG. 1 and different portions will be explained hereinbelow.

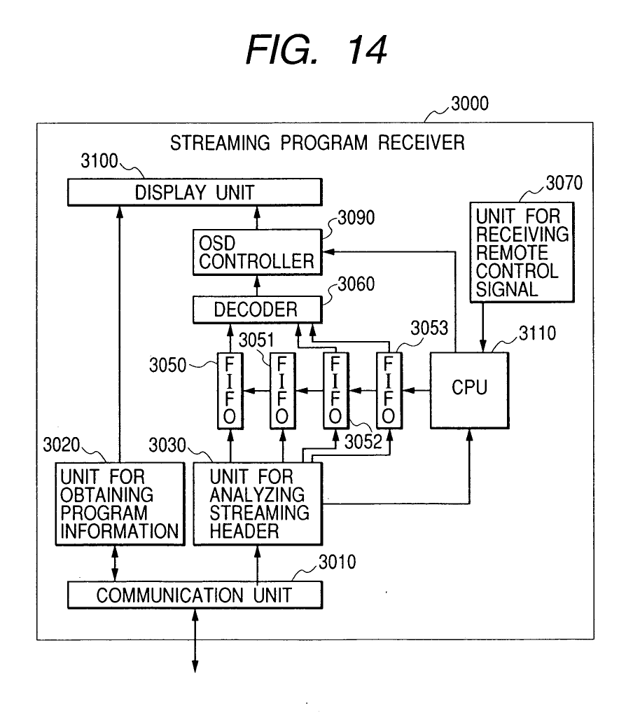

The streaming program receiver 3000 in the second embodiment is shown in FIG. 14. In the diagram, reference numerals 3050 to 3053 denote FIFOs and these FIFOs are different from the FIFOs in the first embodiment.

In the construction of FIG. 14, the operations which are executed until the streaming program receiver 3000 requests the HTML document on the portal display screen from the program distribution server 2000 and finally displays the digest program contents 2600 onto the display unit 3100 are similar to those in the first embodiment.

Subsequently, the operation of the WEB server 2500 will be described.

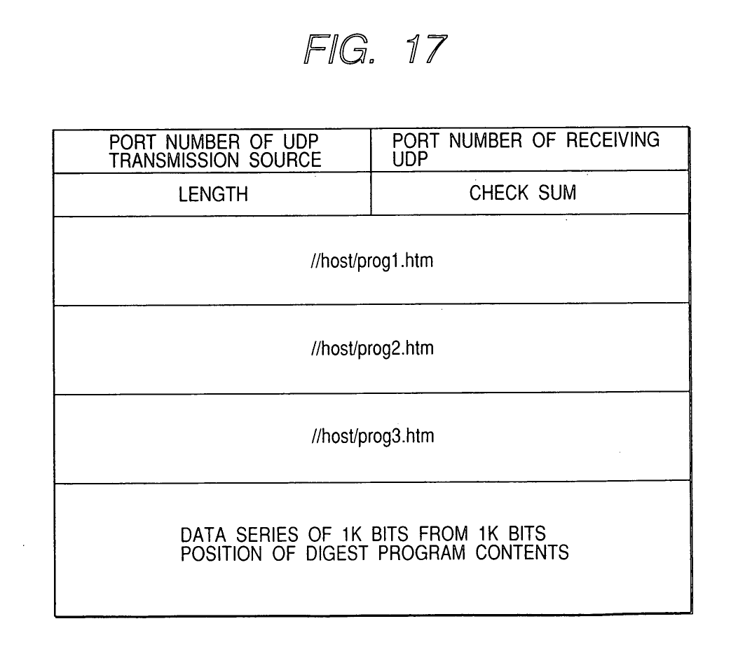

When the digest program contents 2600 is transmitted to the streaming program receiver 3000, the WEB server 2500 in the second embodiment transmits the URL of the HTML document data including the connection information corresponding to the position of the transmission data and the URLs of the HTML document data including the connection information corresponding to the next digest program and the next to next digest program together with the transmission data. A data format at this time is shown in FIG. 17.

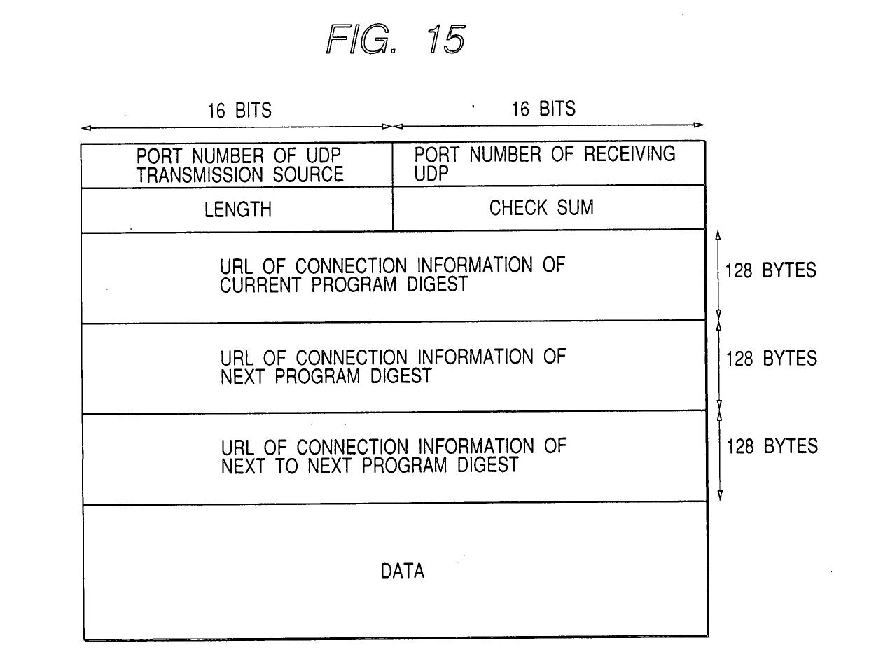

In FIG. 15, it is assumed that each area of the connection information URL is fixed to 128 bytes and order of them has been also predetermined.

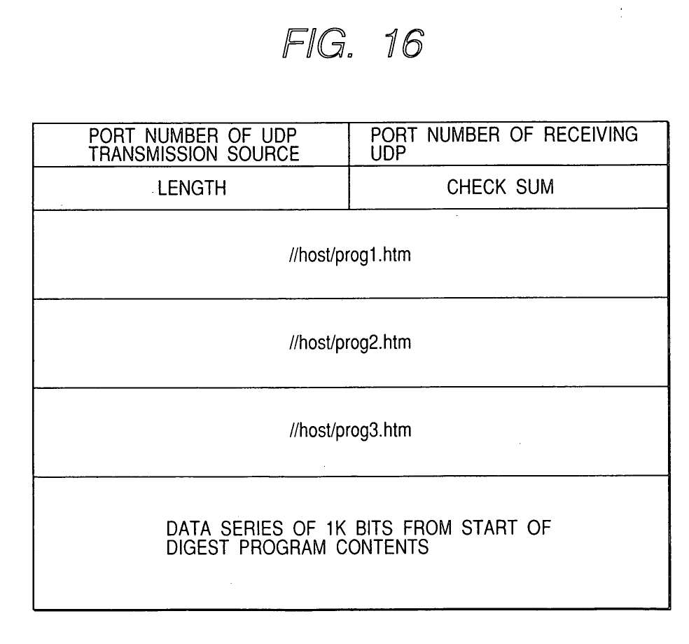

For example, in the case of transmitting the data of 1 kbits from the start of the digest program contents 2600, the URL of the HTML document data corresponding to the position of the transmission data is identified as “//host/prog1.htm” from the URL table 2610. As URLs of the HTML document data including the connection information corresponding to the next digest program and the next to next digest program, “//host/prog2.htm” stored in the position next to preceding URL “//host/prog1.htm” and “//host/prog3.htm” stored in the position next to “//host/prog2.htm” are referred to on the URL table 2610. Thus, data shown in FIG. 16 is transmitted.

In the case of transmitting the subsequent data, that is, the data of 1 kbits from the 1-kbits position of the digest program contents 2600, the URL of the HTML document data corresponding to the position of the transmission data is identified as “//host/prog1.htm” from the URL table 2610 in a manner similar to the above. As URLs of the HTML document data including the connection information corresponding to the next digest program and the next to next digest program, “//host/prog2.htm” and “//host/prog3.htm” are referred to on the URL table 2610 in a manner similar to the above. Thus, data shown in FIG. 17 is transmitted.

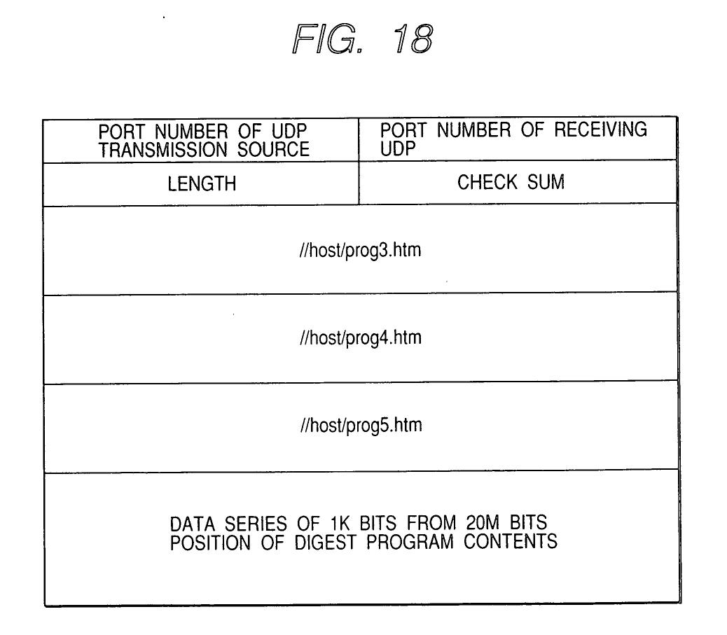

In the case of transmitting the data of 1 kbits from the 20-Mbits position of the digest program contents 2600, the URL of the HTML document data corresponding to the position of the transmission data is identified as “//host/prog3.htm” from the URL table 2610. As URLs of the HTML document data including the connection information corresponding to the next digest program and the next to next digest program, “//host/prog4.htm” stored in the position next to preceding URL “//host/prog3.htm” and “//host/prog5.htm” stored in the position next to “//host/prog4.htm” are referred to on the URL table 2610. Thus, data shown in FIG. 18 is transmitted.

In the streaming program receiver 3000, first, the connection information URL of the received digest program contents 2600 is analyzed in the streaming header analyzing unit 3030. For example, in the case of receiving the data of 1 kbits from the start of the digest program contents 2600, the data shown in FIG. 16 is received and the connection information URLs are identified as follows.

| | |
|---|---|
| Current program digest | “//host/prog1.htm” |
| Next program digest | “//host/prog2.htm” |
| Next to next program digest | “//host/prog3.htm” |

Since the connection information URL has changed (from a state where the connection information URL is not received to a state where it is received), the streaming program receiver 3000 requests the HTML document of “//host/prog1.htm” in a manner similar to the first embodiment and stores the data of the program 1 into the FIFO 3051. Further, in the embodiment, the streaming program receiver 3000 also requests the HTML documents of “//host/prog2.htm” and “//host/prog3.htm”, stores the data of the program 2 into the FIFO 3052, and stores the data of the program 3 into the FIFO 3053, respectively.

Subsequently, when the streaming program receiver 3000 receives the subsequent data, that is, the data (data shown in FIG. 17) of 1 kbits from the 1-kbits position of the digest program contents 2600, it does not execute the operation such as connection establishment or the like because the change in connection information URL is not detected.

After that, when the data of 1 kbits from the 10-Mbits position of the digest program contents 2600 is received, the connection information URLs are identified in the streaming header analyzing unit 3030 as follows.

| | |
|---|---|
| Current program digest | “//host/prog2.htm” |
| Next program digest | “//host/prog3.htm” |
| Next to next program digest | “//host/prog4.htm” |

In this case, since the connection information URL has changed, the streaming program receiver 3000 stops the reception of the data of the program 1 corresponding to the preceding “current program digest”, disconnects the connection thereof, and requests the HTML document of “//host/prog4.htm” which has newly been identified on the basis of the URL.

Subsequently, the reception of the program 4 is started in a manner similar to the above. At this time, the data in the FIFO 3051 used for buffering of the stopped data reception is abandoned and the data of the program 4 which is newly received is stored into the FIFO 3051.

After that, when the data of 1 kbits from the 20-Mbits position of the digest program contents 2600 is received, the connection information URLs are identified in the streaming header analyzing unit 3030 as follows.

| | |
|---|---|
| Current program digest | “//host/prog3.htm” |
| Next program digest | “//host/prog4.htm” |
| Next to next program digest | “//host/prog5.htm” |

In this case, since the connection information URL has changed, the streaming program receiver 3000 stops the reception of the data of the program 2 corresponding to the preceding “current program digest”, disconnects the connection thereof, and requests the HTML document of “//host/prog5.htm” which has newly been identified on the basis of the URL.

Subsequently, the reception of the program 5 is started in a manner similar to the above. At this time, the data in the FIFO 3052 used for buffering of the stopped data reception is abandoned and the data of the program 4 which is newly received is stored into the FIFO 3052.

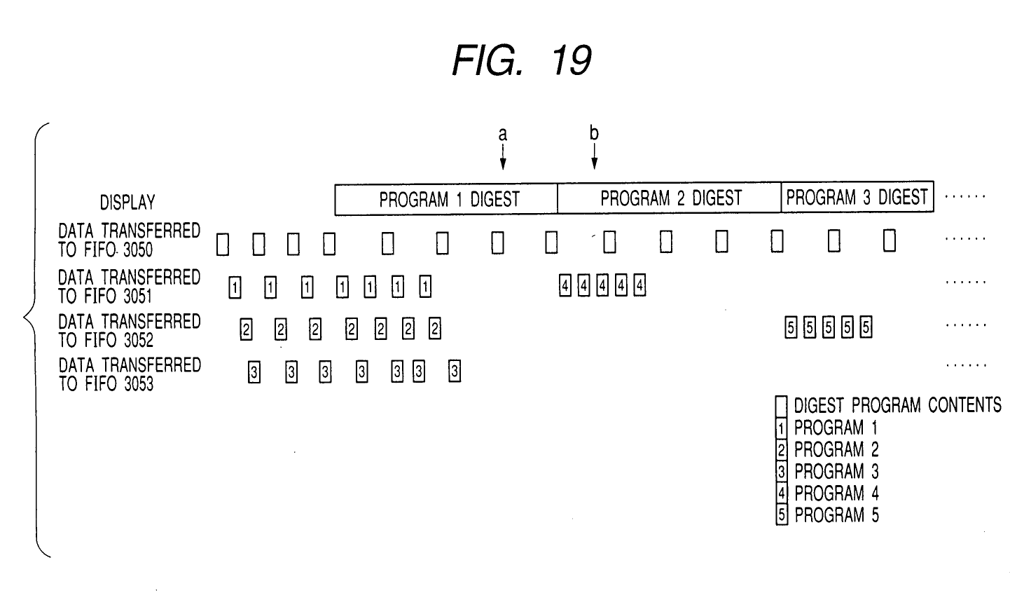

A time-dependent transition diagram of the display contents on the display unit 3100 and the contents of data which is transferred to the FIFOs 3050 and 3053 in the above operation is shown in FIG. 19.

In FIG. 19, the operation which is executed when the user operates the monitoring button on the remote controller at a point of time “a” will be described hereinbelow. It corresponds to the case where while the user monitors the digest program contents 2600, he likes the monitoring program 1 and shifts the monitoring target to the current program in a manner similar to the first embodiment.

The CPU 3110 which detected the operation of the monitoring button controls the decoder 3060 so as to read out the streaming data from the FIFO 3051 because the data in the FIFO 3051 is in a reproducible state, and switches the display contents on the display unit 3100 to the reproduction display screen of the program 1. At the same time, the reception of the digest program contents 2600 is stopped, the connection is disconnected, and further, the buffering is performed. Also with respect to the programs 2 and 3, the data reception is stopped and the connection is disconnected.

After that, since the reception of the digest program contents 2600 is stopped and the change in connection information URL is not detected in the streaming header analyzing unit 3030, the reception of the data of the program 1 is continued and the reproduction display screen of the program 1 is continuously displayed on the display unit 3100.

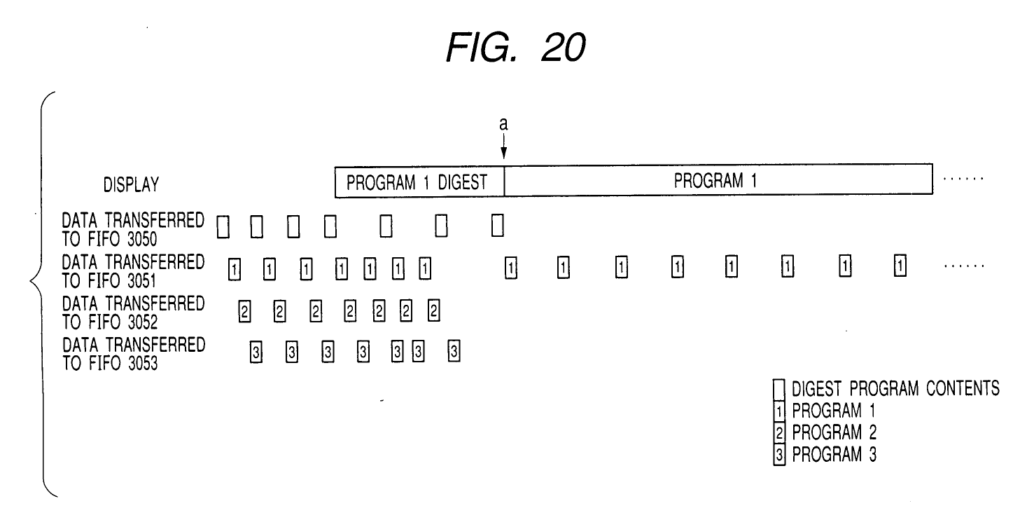

A time-dependent transition diagram of the display contents on the display unit 3100 and the contents of data which is transferred to the FIFOs 3050 and 3053 in this case is shown in FIG. 20.

As mentioned above, while the digest program is monitored, the user can soon start to monitor the current program without a waiting time for buffering or the like by the simple operation such as only the operation of the monitoring button.

Returning to FIG. 19, the operation which is executed when the user operates the monitoring button on the remote controller at a point of time “b” will be described hereinbelow. It corresponds to the case where while the user monitors the digest program contents 2600, he likes the monitoring program 2 and shifts the monitoring target to the current program in a manner similar to the first embodiment.

The CPU 3110 which detected the operation of the monitoring button controls the decoder 3060 so as to read out the streaming data from the FIFO 3052 because the data in the FIFO 3052 is in a reproducible state and switches the display contents on the display unit 3100 to the reproduction display screen of the program 2. At the same time, the reception of the digest program contents 2600 is stopped, the connection is disconnected, and further, the buffering is performed. Also with respect to the programs 3 and 4, the data reception is stopped and the connection is disconnected.

After that, the reproduction display screen of the program 2 is continuously displayed on the display unit 3100.

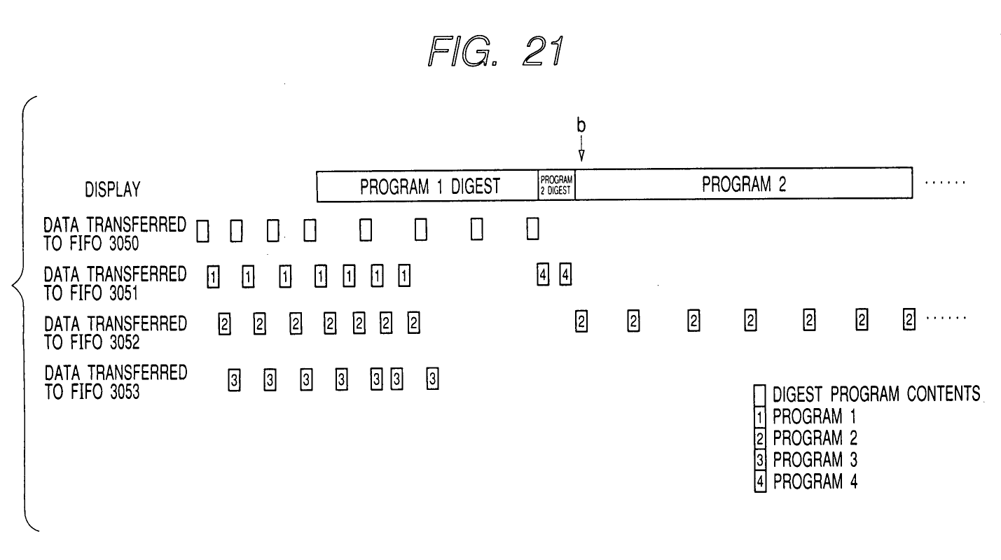

A time-dependent transition diagram of the display contents on the display unit 3100 and the contents of data which is transferred to the FIFOs 3050 and 3053 in the above case is shown in FIG. 21.

As mentioned above, the user can soon monitor the current program without a waiting time for buffering or the like by the simple operation such as only the operation of the monitoring button even if he operates the monitoring button just after the program scene of the digest program changed during the monitoring of the digest program.

The display contents on the display unit 3100 and the operation which is executed when the user operates the return button upon monitoring of the current program are similar to those in the first embodiment.

(Third Embodiment)

Subsequently, the third embodiment will be described.

A construction of a main section of the streaming program distribution system in the third embodiment is similar to that of the second embodiment and different portions will be explained hereinbelow.

In the third embodiment, the operations which are executed until the streaming program receiver 3000 requests the HTML document on the portal display screen from the program distribution server 2000 and finally displays the digest program contents 2600 onto the display unit 3100, the data of the program 1 is buffered into the FIFO 3051, the data of the program 2 is buffered into the FIFO 3052, and the data of the program 3 is buffered into the FIFO 3053, that is, the operations which are executed until a state shown in FIG. 19 are similar to those in the second embodiment.

In FIG. 19, when the user operates the reservation button on the remote controller at a point of time “a” (corresponds to the case where although he likes the program 1 during the monitoring of the digest program contents 2600, he does not shift the monitoring target to the current program), the CPU 3110 which detects the operation of the reservation button sets a flag indicative of the reservation into the FIFO 3051 in which the data of the program 1 has been stored.

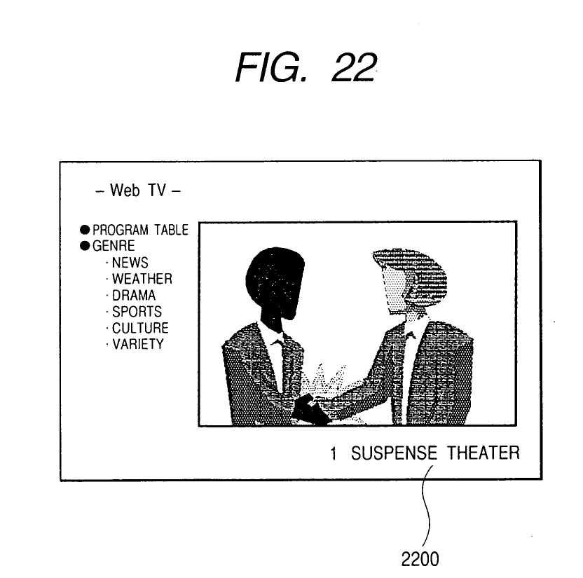

In this instance, the CPU 3110 controls the OSD controller 3090 so that the FIFO 3051 in which the flag indicative of the reservation button has been set and a “1” button on the remote controller are made to correspond to each other and information showing that the buffering of the program 1 has been reserved and information showing the corresponding button on the remote controller, that is, “1” are displayed on the display unit 3100. Display contents on the display unit 3100 at this time are shown in FIG. 22. Reference numeral 2200 in FIG. 22 denotes those information.

After that, when the data of 1 kbits from the 10-Mbits position of the digest program contents 2200 is received, the connection information URLs are identified in the streaming header analyzing unit 3030 as follows.

| | |
|---|---|
| Current program digest | “//host/prog2.htm” |
| Next program digest | “//host/prog3.htm” |
| Next to next program digest | “//host/prog4.htm” |

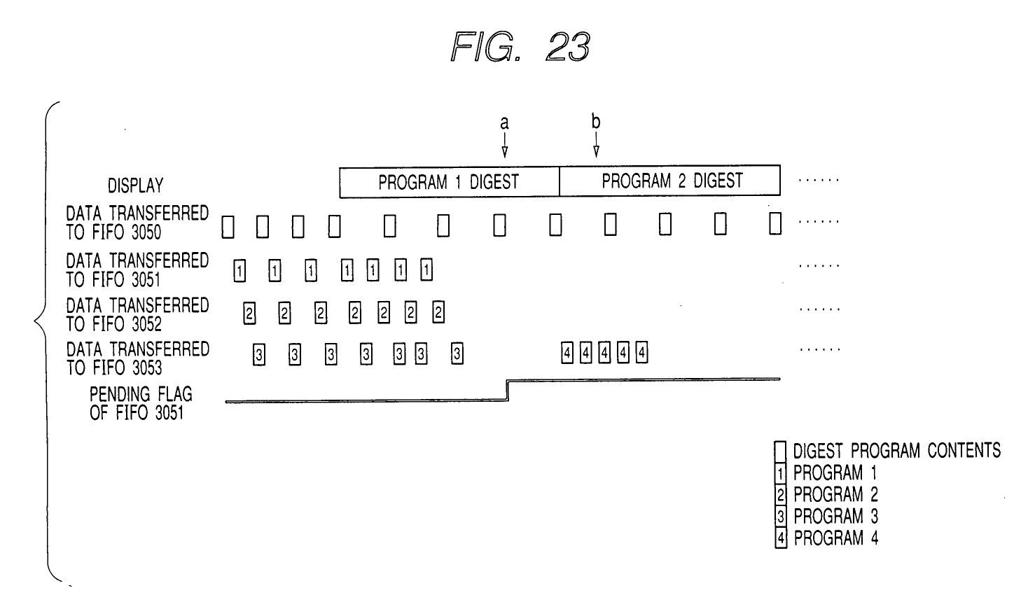

In the embodiment, in this case, since the connection information URL has changed, first, the streaming program receiver 3000 checks the reservation flag of the FIFO 3051 in which the data of the current program digest has already been stored. Since the reservation flag has been set here, the receiver 3000 checks the reservation flag of the FIFO 3053 in which the data of the next to next program digest has already been stored. Since the reservation flag is not set here, the streaming program receiver 3000 stops the data reception of the program 3, disconnects the connection, and requests the HTML document of “//host/prog4.htm” which was newly identified on the basis of the URL. After that, the reception of the program 4 is started. At this time, the data of the program 4 which is newly received is stored into the FIFO 3052 in which the stopped data has been stored. The above time-dependent transition diagram is shown in FIG. 23.

When the user operates the monitoring button on the remote controller at a point of time “b” in the state shown in FIG. 23, the user can soon start to monitor the current program of the program 2 without a waiting time for buffering or the like in a manner similar to the second embodiment.

When the user operates the “1” button on the remote controller at a point of time “b” in the state shown in FIG. 23, it corresponds to the case where he likes the program 1 which has been reserved earlier than the program 2 during the monitoring of the digest program contents 2600 and shifts the monitoring target to the current program of the program 1.

The CPU 3110 which detected the operation of the “1” button controls the decoder 3060 so as to read out the streaming data from the FIFO 3051 because the data in the FIFO 3051 corresponding to the “1” button is in a reproducible state, and switches the display contents on the display unit 3100 to the reproduction display screen of the program 1. The reception of the digest program contents 2600 and the data which is being buffered is stopped and the connection is disconnected.

As mentioned above, the user can soon monitor the current program of the past digest program which has been reserved earlier without a waiting time for buffering or the like only by the button operation on the remote controller during the monitoring of the digest program.

Returning to FIG. 19, when the user operates the reservation button on the remote controller at a point of time “b” (it corresponds to the case where although he likes the program 2 during the monitoring of the digest program contents 2600, he does not shift the monitoring target to the current program), the CPU 3110 which detects the operation of the reservation button sets the flag indicative of the reservation into the FIFO 3052 in which the data of the program 2 has been stored.

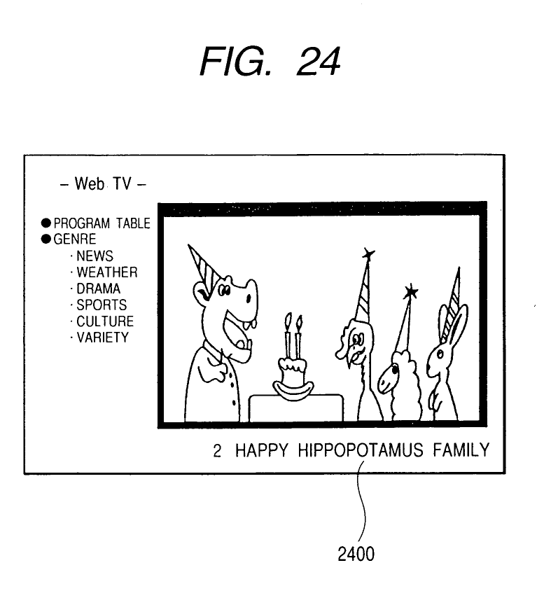

At this time, the CPU 3110 controls the OSD controller 3090 so that the FIFO 3052 in which the flag indicative of the reservation button has been set and a “2” button on the remote controller are made to correspond to each other and the information showing that the buffering of the program 1 has been reserved and information showing the corresponding button on the remote controller, that is, “2” are displayed on the display unit 3100. Display contents on the display unit 3100 at this time are shown in FIG. 24. Reference numeral 2400 in FIG. 24 denotes those information.

After that, when the data of 1 kbits from the 20-Mbits position of the digest program contents 2400 is received, the connection information URLs in the streaming header analyzing unit 3030 are identified as follows.

| | |
|---|---|
| Current program digest | “//host/prog3.htm” |
| Next program digest | “//host/prog4.htm” |
| Next to next program digest | “//host/prog5.htm” |

In this case, since the connection information URL has changed, first, the streaming program receiver 3000 checks the reservation flag of the FIFO 3052 in which the data of the current program digest has already been stored. Since the reservation flag has been set here, the receiver 3000 checks the reservation flag of the FIFO 3051 in which the data of the next to next program digest has already been stored. Since the reservation flag is not set here, the streaming program receiver 3000 stops the data reception of the program 3, disconnects the connection, and requests the HTML document of “//host/prog4.htm” which was newly identified on the basis of the URL. After that, the reception of the program 4 is started.

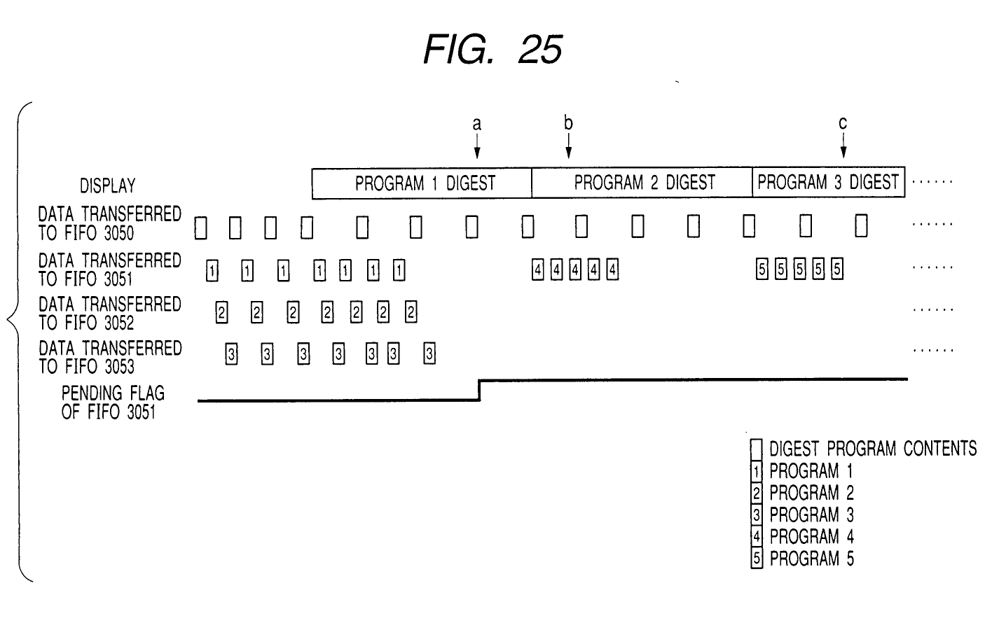

At this time, the data of the program 4 which is newly received is stored into the FIFO 3051 in which the stopped data has been stored. The above time-dependent transition diagram is shown in FIG. 25.

When the user operates the monitoring button on the remote controller at a point of time “c” in the state shown in FIG. 25, the user can soon start to monitor the current program of the program 3 without a waiting time for buffering or the like. When the user operates the “2” button on the remote controller, the user can soon start to monitor the current program of the program 2 without a waiting time for buffering or the like.

(Other embodiments)

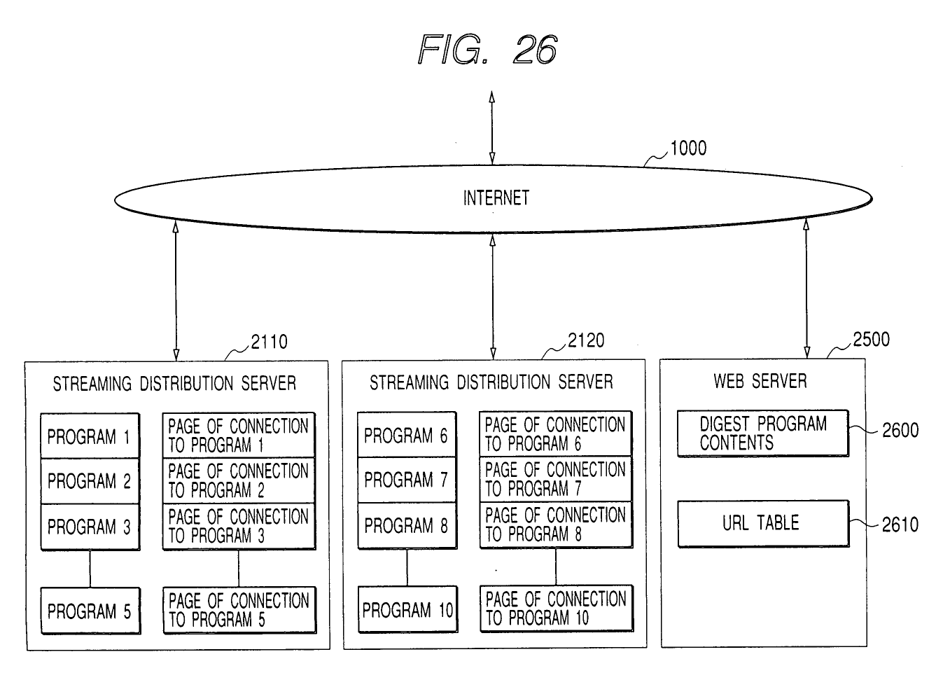

The streaming distribution server 2100 and the WEB server 2500 in the first to third embodiments can be separated as shown in FIG. 26.

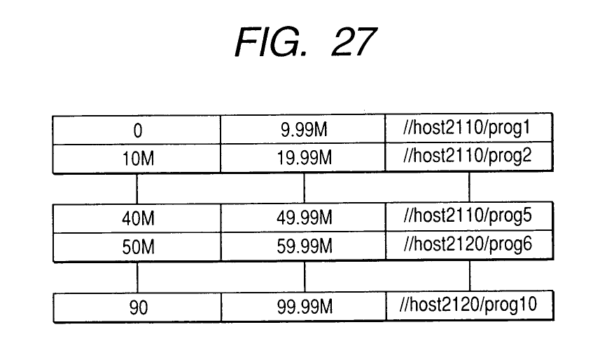

In FIG. 26, it is assumed that the streaming program data of the programs 1 to 5 has been stored in a streaming distribution server 2110 and the streaming program data of the programs 6 to 10 has been stored in a streaming distribution server 2120, respectively. In this case, if the streaming distribution server 2110 is assumed to be “host2110” and the streaming distribution server 2120 is assumed to be “host2120”, the URL table 2610 in the WEB server 2500 is as shown in FIG. 27.

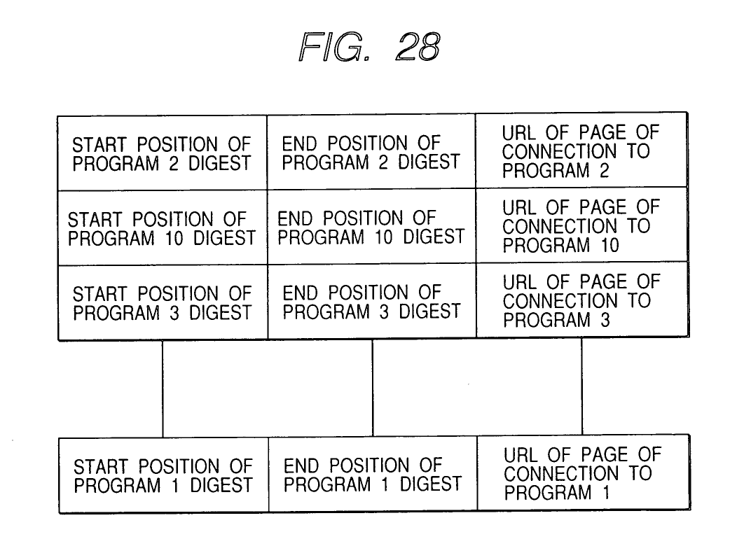

As will be easily presumed from the first and second embodiments, order in the URL table 2610 in the first embodiment can be made different as shown in FIG. 28.

Although the FIFOs and the buttons on the remote controller have been made to correspond to each other together with the operation of the reservation button in the third embodiment, the button numbers can be also preliminarily statically allocated as follows.

| | |
|---|---|
| FIFO 3051 | button “1” |
| FIFO 3052 | button “2” |
| FIFO 3053 | button “3” |

In the first to third embodiments, the format of the UDP packet has been constructed in a manner such that the URL of the HTML document data including the connection information is arranged just after the UDP header and the data of the digest program contents 2600 is arranged after the URL. However, the data format of the digest program contents 2600 can be set to a TS (Transport Stream) which is specified by MPEG2 (Moving Picture Experts Group Phase 2) and ISO/IEC13818 and can be also constructed in a manner such that TS data is transmitted in the UDP packet and the URL of the HTML document data including the connection information is included in an adaptation field or the like in a TS packet.

The buffering from the FIFO 3051 to the FIFO 3053 simultaneously occurs at the initial stage in the second and third embodiments. At this time, it is desirable to allocate priorities to the FIFOs and execute the buffering to them. In this case, the data corresponding to the current program and having a possibility that the current program digest is immediately needed with respect to time is set to the highest priority as follows.

| | |
|---|---|
| High priority | FIFO 3051 |
| Middle priority | FIFO 3052 |
| Low priority | FIFO 3053 |

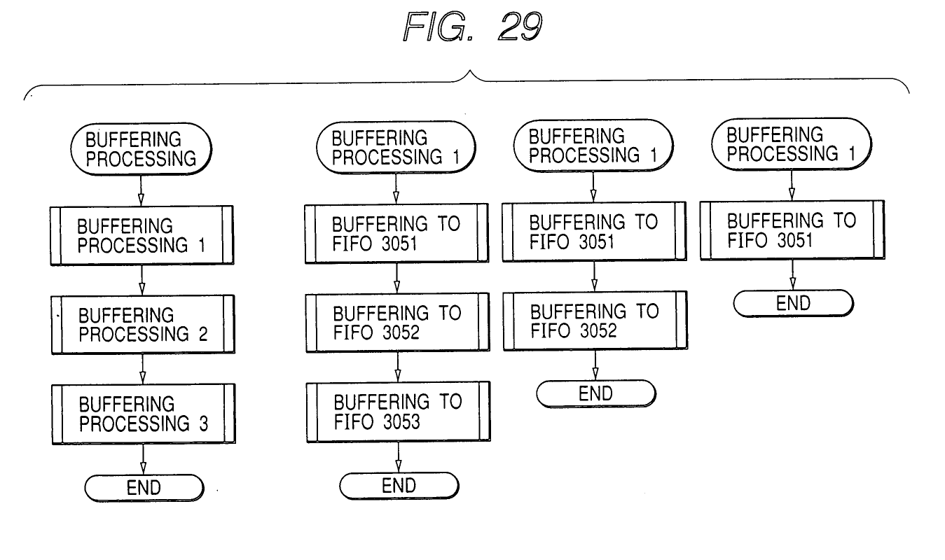

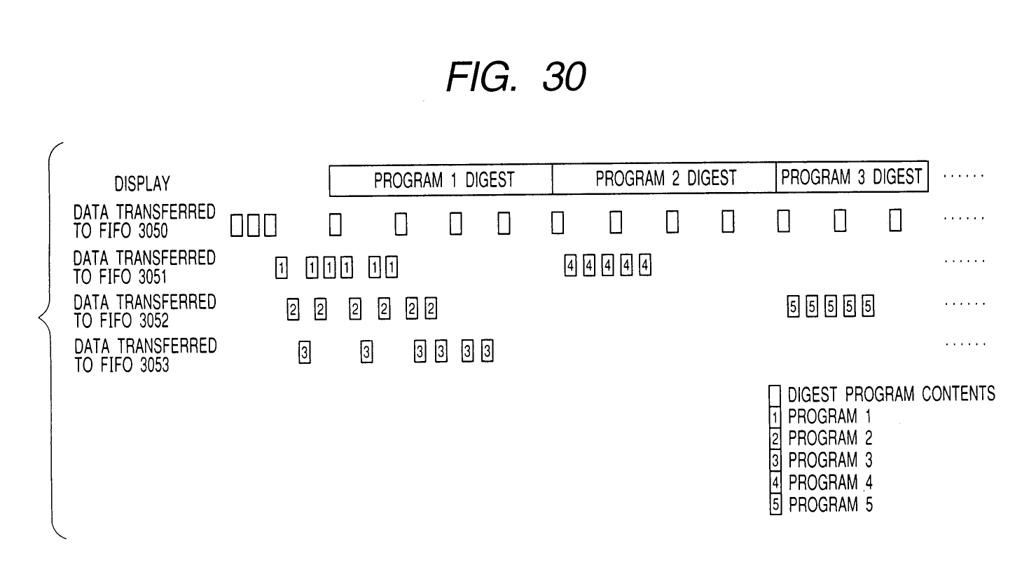

Since the apparatus operates in accordance with a processing flow shown in, for example, FIG. 29, the buffering of the FIFO 3051 is preferentially executed. A time-dependent transition diagram of the display contents of the display unit 3100 and the contents of data which is transferred to the FIFO 3050 to the FIFO 3053 at this time is shown in FIG. 30. The requesting and interrupting processes of the buffering according to an amount of data in the FIFO 3050 are omitted in the processing flow shown in FIG. 29.

By the above buffering control, the waiting time until the current program is monitored in the case where the user immediately operates the monitoring button after the start of the monitoring of the digest program can be shortened.

As described above, according to the invention, since the corresponding main video data is received from the network and stored during the monitoring of the digest program, the main video image can be promptly displayed without a waiting time for buffering or the like.

1. A receiving apparatus for receiving stream data including main video data via a network, comprising:
communicating means for receiving via said network a digest stream including digest data showing a digest of each of said plurality of main video data and position information showing a position on said network where connection information for connecting to at least one of said plurality of main video data exists;
outputting means for outputting a video signal regarding said digest data received by said communicating means in order to display; and
system control means for controlling said communicating means so as to receive said connection information via said network on the basis of said position information received by said communicating means and receive said main video data in accordance with said connection information.

2. An apparatus according to claim 1, wherein said system control means further controls display control means so that said main video data stored in storing means is outputted to a display apparatus in response to a display instruction of a main video image by instructing means.

3. An apparatus according to claim 2, wherein said system control means controls said communicating means and said storing means so that only the main video data corresponding to said digest data regarding a video image which is being displayed by said display apparatus is received and stored into said storing means.

4. An apparatus according to claim 3, wherein said system control means controls said communicating means and said storing means so that the main video data which is received by said communicating means is changed in accordance with a change in said position information in said digest stream and the main video data which is newly received after the change is stored into said storing means.

5. An apparatus according to claim 2, wherein said system control means controls said communicating means and said storing means so that a plurality of main video data corresponding to said digest data regarding a video image which is being displayed by said display apparatus and a plurality of digest data subsequent to said digest data is received and stored into said storing means.

6. An apparatus according to claim 5, wherein said system control means further controls said display control means so that the main video data corresponding to the video signal outputted to said display apparatus among said plurality of main video data stored in said storing means is outputted to said display apparatus in response to a reproducing instruction of the main video image by reproduction instructing means.

7. An apparatus according to claim 6, wherein said system control means controls said display control means so that if the instruction is made by said reproduction instructing means while said main video data is outputted to said display apparatus, a predetermined one of said plurality of main video data stored in said storing means is read out and outputted.

8. An apparatus according to claim 7, wherein said system control means controls said communicating means and said storing means so that the main video data which is received by said communicating means is changed in accordance with the instruction made by said reproduction instructing means and the newly received main video data is stored.

9. An apparatus according to claim 8, wherein said system control means controls said storing means so that when an instruction is made by reservation instructing means, the newly received main video data among said plurality of main video data stored in said storing means is stored.

10. An apparatus according to claim 5, wherein said system control means controls said communicating means and said storing means so that said plurality of main video data is received and stored in order according to priorities of said plurality of main video data.

11. An apparatus according to claim 10, wherein said priorities correspond to reproducing order in said digest stream.

12. An apparatus according to claim 2, wherein said system control means controls said display control means so that predetermined information is displayed by said display apparatus in accordance with an amount of said main video data stored in said storing means.

13. An apparatus according to claim 1, wherein said position information includes a URL of said connection information and said connection information is described by HTML.

14. A program distributing method of transmitting said digest stream to the receiving apparatus according to claim 1 via said network.

15. A program distributing method of distributing said connection information and said main video data to the receiving apparatus according to claim 1 via said network.

16. A receiving method of receiving stream data including main video data via a network, comprising the steps of:
receiving via said network a digest stream including digest data showing a digest of each of said plurality of main video data and position information showing a position on said network where connection information for connecting to at least one of said plurality of main video data exists;
outputting a video signal regarding said received digest data in order to display it; and
controlling communicating means so as to receive said connection information via said network on the basis of said received connection information and receive said main video data in accordance with said connection information.
